(19) United States
(12) Patent Application Publication
(10) Pub. No.: US 2014/0354807 A1
(43) Pub. Date: Dec. 4, 2014

(54) JEWELRY BOX CAMERA

(71) Applicant: Yes Cam, LLC, Holland, MI (US)

(72) Inventors: Scott Michael Brandonisio, Troy, MI (US); Scott William Bahash, Grosse Pointe, MI (US); Elliot Joshua Barney, Holland, MI (US); Nicholas Donald Joseph Haugen, Holland, MI (US); Russell Brian Fyfe, Liberty, IL (US)

(73) Assignee: Yes Cam, LLC, Holland, MI (US)

(21) Appl. No.: 14/287,578

(22) Filed: May 27, 2014

Related U.S. Application Data
(60) Provisional application No. 61/827,838, filed on May 28, 2013.

(51) Int. Cl. A45C 11/16; H04N 7/18

(52) U.S. Cl. CPC A45C 11/16; H04N 7/188
USPC 348/143

(57) ABSTRACT

A jewelry box includes a first person, exteriorly mounted, video camera. In one embodiment, a generally standard engagement ring box contains a video camera and a video camera chip, which are capable of recording both audio and video of an event, such as a wedding proposal. The ring box may include an exterior surface with multiple boreholes drilled into its base. The boreholes may be provided with components for recording, storing and transferring audio and video content. In one embodiment, the components include a camera lens, LED, data/charging port, and microphone, each with access to the exterior of the box, as well as a user input switch or button to turn the device camera on and off. The present invention provides an effective way to hide the camera for a desired view for the proposal—including the time period before, during and after the proposal.

### BACKGROUND OF THE INVENTION

The process of proposing is one of the largest milestones in a couple's relationship. While many couples would love to be able to capture a tangible memory to remember this event, many struggle between keeping it intimate and recording it in some way. Some individuals try to solve this problem by soliciting friends to be their professional photographer and video tape these scenes. However these methods often ruin the privacy and intimacy of the moment. In addition, photographers from a distance are unable to capture a first person reaction of a proposal. What has yet to exist is a device that captures a video from the first person point of the view when the fiancé is presented with the engagement ring.

Proposers continue to explore additional options to control when and what they record of their proposer from their viewpoint.

### SUMMARY OF THE INVENTION

The present invention solves the above noted problems through its first person, exteriorly mounted, video camera.

In one embodiment, the present invention includes a generally standard engagement ring box that contains a video camera and a video camera chip, which are capable of recording both audio and video of a proposal. The ring box may include an exterior surface with multiple boreholes drilled into its base. The boreholes may be provided with components for recording, storing and transferring audio and video content. In one embodiment, the components include a camera lens, LED, data/charging port, and microphone, each with access to the exterior of the box, as well as a user input switch or button to turn the device camera on and off.

In one embodiment, the device is portable, lightweight and invisible to the subject of the proposal. Thus, the present invention provides an effective way to hide the camera for capturing a more desired view of the proposal—including the time period before, during and after the proposal.

In another embodiment, videos from the device can be used as video editing material to be shared on “save the date” announcements, and at wedding receptions, bridal showers, anniversaries and many other events.

### BRIEF DESCRIPTION OF THE DRAWINGS

FIG. 1 is a front view of a ring box according to one embodiment of the present invention.

FIG. 2 is a side view thereof.

FIG. 3 is a front view of a ring box according to a second embodiment.

FIG. 4 is a side view thereof.

FIG. 5 is a front view of a ring box according to a third embodiment.

FIG. 6 is a side view thereof.

FIG. 7 is a front perspective view of a ring box according to a fourth embodiment.

FIG. 8 is a back perspective view thereof.

FIG. 9 is a front perspective view of a ring box in the closed position according to the fourth embodiment.

FIG. 10 is a back perspective view thereof.

### DETAILED DESCRIPTION OF THE CURRENT EMBODIMENTS

A ring box according to the current embodiments of the invention is shown in the Figures and generally designated 1. The main aspect of the invention is built into a container, such as a conventional ring box, for storage. The container has an upper and lower portion each with a front, rear, top, and bottom surfaces. The upper portion forms a lid, which has a top surface and a bottom surface that forms a first lip meanwhile the bottom portion forms a base that has a bottom surface and a top surface that forms a second lip. The bottom portion generally contains a pouch that holds a ring. The top portion is connected to the bottom portion at the first and second lip, for example, with a hinge or other conventional connector. This hinge gives the container the ability to have an open and closed configuration.

A camera lens hole may be formed in a portion of the box, in either the top portion or the bottom portion of the box. In one embodiment, the camera lens hole is located in the front face of the box (i.e., the face opposite the hinge). The “side” of the ring box can reference any face that is not the front, top, or bottom of the ring box.

The camera lens may be mounted on, or otherwise connected to, a camera chip, which is generally conventional and includes an image sensor, a processor and any other video camera components mounted on a circuit board. The camera lens is positioned to focus the image on the image sensor. The camera chip may contains an internal SD card based DVR that saves the recorded footage and audio to a memory module that is mounted on or connected to the circuit board. The function of the camera is controlled by a switch that is operable by the user, which may be a either a push button or a flip switch.

In an embodiment including a push button, a single button press of a set duration may power on the device and initiate recording. Another single button press of a set duration will stop the device recording, save the recording to the internal DVR and shutdown the device. The button may be visible to the user. Alternatively, the button can be hidden within the ring boxes outer material and can be located by feeling that part of the box.

In an embodiment controlled by a flip switch, the switch may have 2 positions, such as Recording and Off. Moving the flip switch to the recording position will power on the device and initiate recording. Moving the switch back to the off position will stop the devices recording, save the recording to the internal DVR and shutdown the device.

One or more LED's may be included for indicating the operating state of the camera. The chip may be programmed to operate an LED, for instance, during recording. In one embodiment, the LED's are located either directly on the camera chip, or extended via thin gauge wire to a different location inside the box. Optionally, a small eccentric rotating device that when spun creates a minor vibration can also be used for additional user feedback. The vibrating device can be located either directly on the camera chip, or extended to a different hidden location inside the ring box via thin gauge wire.

A battery pack may be included to provide power to the camera. The battery pack may be extended from the camera chip via thin gauge wire. The battery may be mounted in a hidden location in either the top or bottom half of the ring box.

In the current embodiments, only the camera lens, USB port (described below), LED, and user input button/switch (also described below) are visible in the exterior of the ring box, to provide the appearance of an ordinary ring box. All other electronics may be hidden within portions of the ring box such that they are not visible from the user's views. In order to better hide the camera from outside view, the ring box may include a thin piece of one-way reflective material that matches the color of the box. This material may be placed in front of the camera lens. Because the reflective material is one-way and translucent, it will do little to hinder the camera lens' recording view.

The camera lens itself may be attached within the box in a variety of ways. In one embodiment, the camera lens is adhered within the lens hole in the ring box's front top half.

The ring box may also include a USB port to provide direct access to the content stored on the camera chip using a standard computer or other type of device, just like a USB flash drive. The camera module battery is charged from the USB port.

All components may be secured to the interior surface of the box with adhesive, small screws, or a plastic plate designed to house each component. The internal components are then covered with portions of the outer faces of the ring box. Any components in the bottom portion of the box may be covered by the ring cushion. Any components in the top half of the box may be covered by an insert matching the same general texture and material of the ring box cushion.

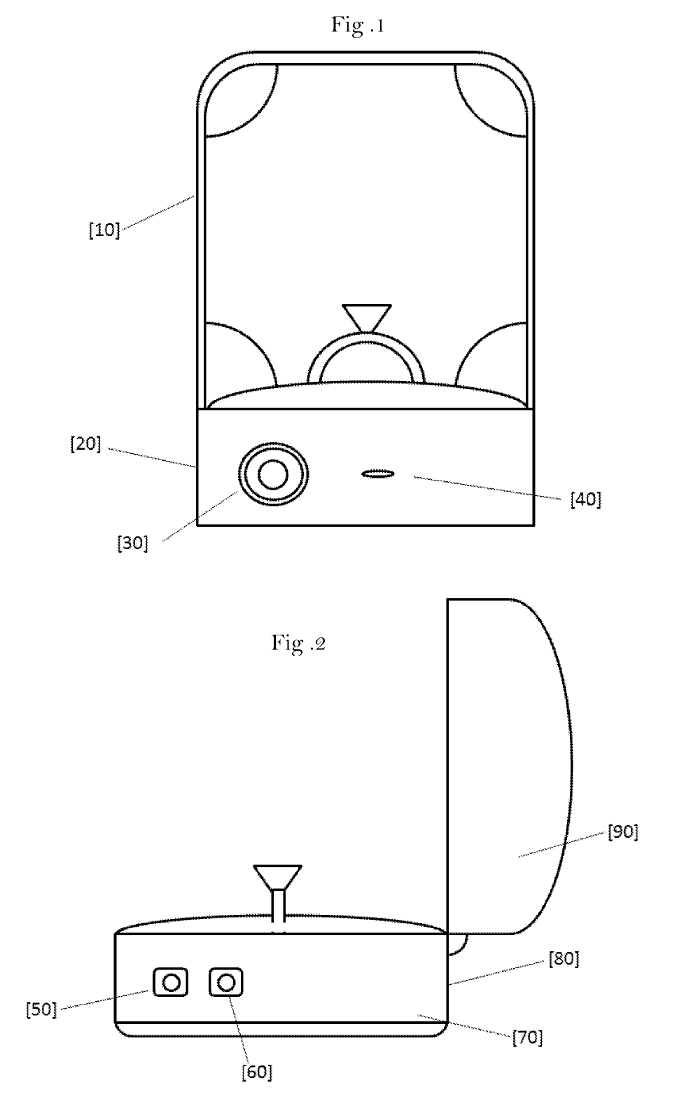

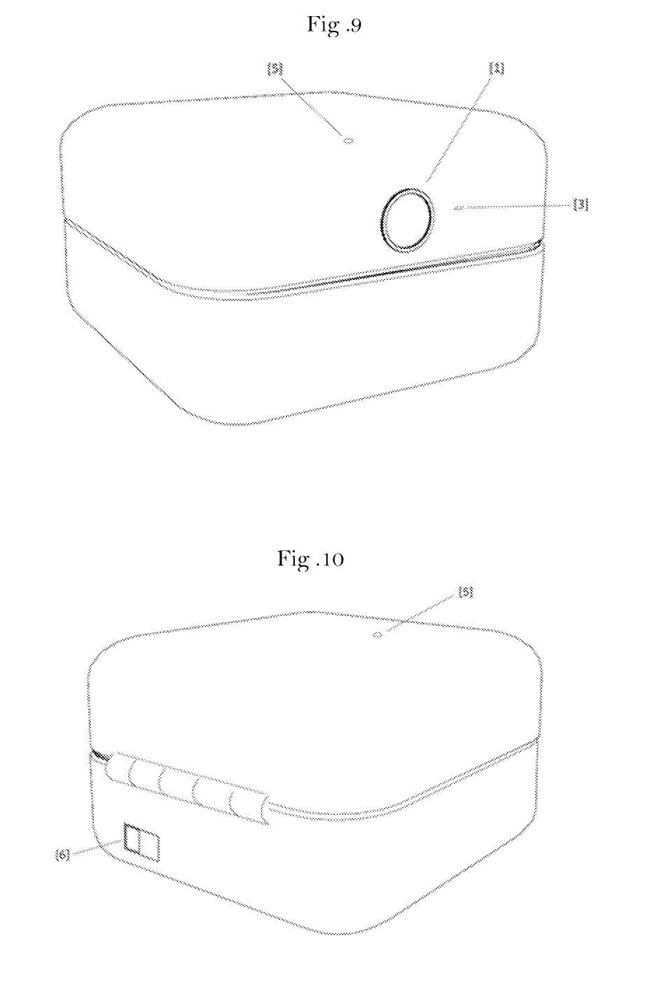

Various examples of the ring box according to the present invention are shown in FIGS. 1-10. These examples each illustrate a particular configuration of the components described above.

A first example of a ring box according to the present invention is shown in FIGS. 1 and 2. In this example, six holes are bored into a standard ring box [10]. One large hole in the front bottom half for the lens [30], one small hole in the front bottom half for the microphone [40], two holes on the bottom half side for buttons [50, 60], one hole on the opposite bottom half side for a micro USB input [20], and one in the back for LED output [80].The following pieces are extended from the camera chip via a thin gauge wire and solder to their respective locations: both input buttons, the LED output light, the chip battery, and the microphone. Exposed solder on the chip is coated with nonconductive RTV for stability. The battery, which powers the camera chip, is located in the top lid of the engagement ring box hidden from view behind the box's internal fabric [90]. Located in the bottom of the box is the camera chip, which is discretely wired to the battery in the lid [70]. The custom camera chip holder is located beneath the chip for stabilization. The camera lens itself will be adhered to the large hole in the front bottom half [30]. The outer ring box material which covers the main structure of the box is cut for access to the USB port. The buttons alternatively are hidden within the fabric and can be located by feeling the side of the box. The LED is placed in the back small hole facing the user. All components are adhered to the interior surface of the box with hot glue or an equivalent. The internal components are then covered with the ring cushion and all camera components are concealed in the lower lid except for the battery. The video format for recording is an AVI file which is universally recognized on every major operating system and can be played with most media software.

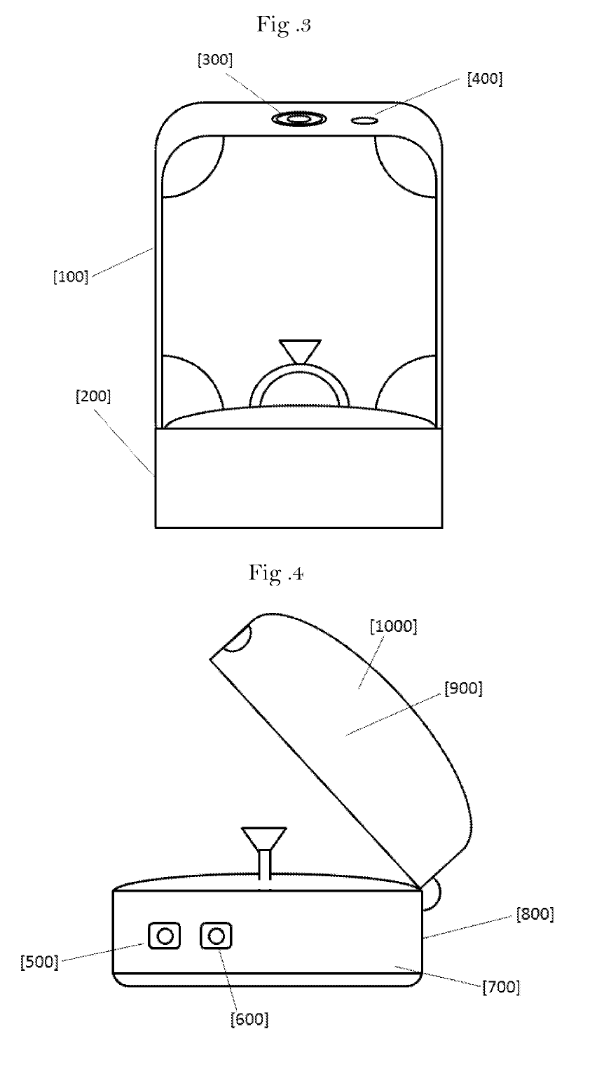

A second example of a ring box according to the present invention is shown in FIGS. 3 and 4. In this embodiment, six holes are bored into a standard ring box [100]. One large hole in the front top half for the lens [300], one small hole in the front top half for the microphone [400], two holes on one bottom half side for buttons [500, 600], one hole on the opposite top half side for a micro USB input [200], and one in the back for LED output [800].

The following pieces are extended from the camera chip via thin gauge wire and solder to their respective locations: both input buttons, the LED output light, the chip battery, and the microphone. Exposed solder on the chip is coated with nonconductive RTV for stability. The battery, which powers the camera chip, is located in the bottom half of the engagement ring box hidden from view under the boxes ring cushion [700]. Located in the top of the box is the camera chip [9], which is discretely wired to the battery in the bottom. The custom camera chip holder is located above the chip for stabilization [1000]. The camera lens itself will be adhered to the large hole in the front top half [300].

The outer ring box material which covers the main structure of the box is cut for access to the USB port. The buttons alternatively are hidden within the fabric and can be located by feeling the lower side of the box. The LED is placed in the back small hole facing the user. All components are adhered to the interior surface of the box with hot glue or an equivalent. The internal components are then covered with the ring cushion and all camera components are concealed in the upper lid except for the battery. The video format for recording is an AVI file which is universally recognized on every major operating system and can be played with most media software.

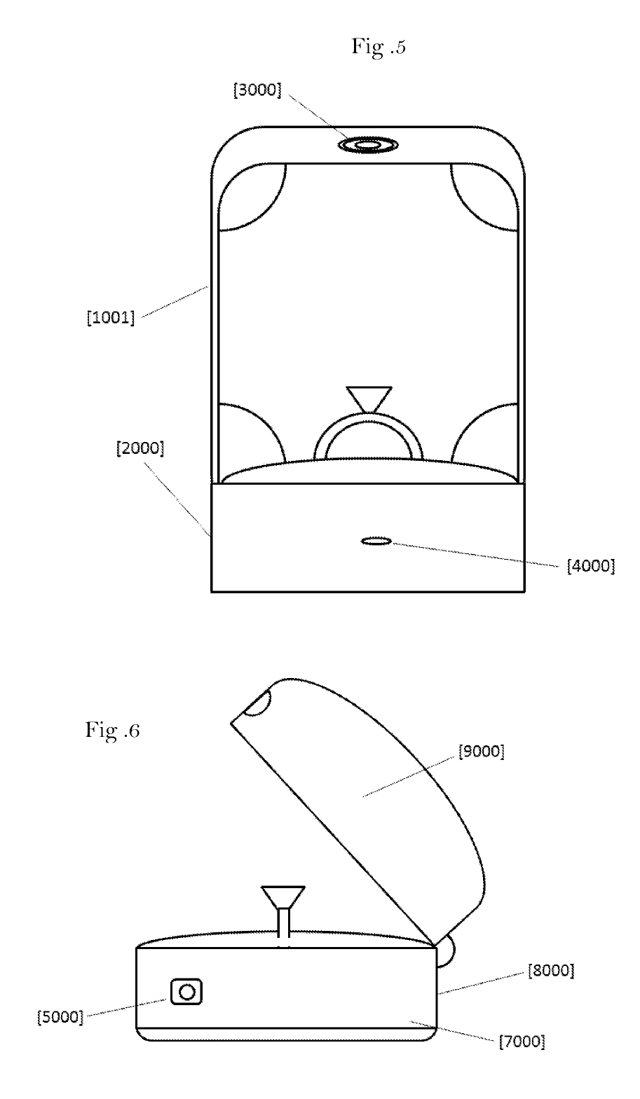

A third example of a ring box according to the present invention is shown in FIGS. 5 and 6. In this embodiment, five holes are bored into a standard ring box [1001]. One large hole in the front top half for the lens [3000], one small hole in the front bottom half for the microphone [4000], one hole on the bottom half side for a button [5000], one hole on the opposite bottom half side for a micro USB input [2000], and one in the back for LED output [8000].

The following pieces are extended from the camera chip via thin gauge wire and solder to their respective locations: the input buttons, the LED output light, the chip battery, and the microphone. Exposed solder on the chip is coated with nonconductive RTV for stability. The battery, which powers the camera chip, is located in the lid of the engagement ring box hidden from view under the boxes internal fabric [9000]. Located in the bottom of the box is the camera chip [7000], which is discretely wired to the battery in the lid. The custom camera chip holder is located below the chip for stabilization. The camera lens itself is extended using a ribbon wire from the chip in the bottom half to the hole in the front top half. This ribbon is hidden from view behind the internal jewelry fabric/material. The lens is then adhered to the large hole in the front top half [3000].

The outer ring box material which covers the main structure of the box for access to the USB port. The buttons alternatively are hidden within the fabric and can be located by feeling the lower side of the box. The LED is placed in the back small hole facing the user. All components are adhered to the interior surface of the box with hot glue or an equivalent. The internal components are then covered with the ring cushion and all camera components are concealed in the lower lid except for the battery and camera lens.

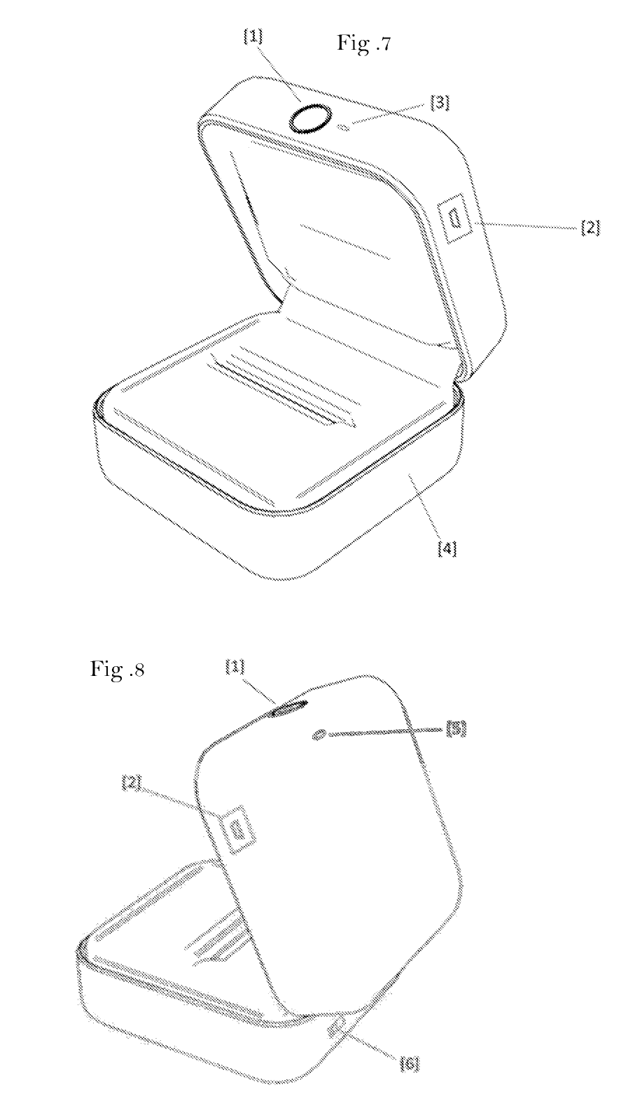

A fourth example of a ring box according to the present invention is shown in FIGS. 7-10. In this embodiment, four holes are bored into a standard ring box. One hole in the front top half for the lens and microphone [1] , one hole in the back half for the activating switch or button [6], one hole on the side top half side for USB input [2], and one whole in the top for LED feedback [5]. The camera module is located in the top half of the ring box, hidden from view behind the boxes internal upper insert. The battery, which powers the camera module, is also located in the top lid of the engagement ring box hidden from view behind the boxes internal insert. A custom camera holder made of plastic or equivalent material may be placed in the upper lid as well in order to house the camera and battery, increasing the structural integrity and stability of the electrical components.

The camera lens will be adhered to the large hole in the front bottom half. A thin piece of one-way reflective material that matches the color of the box may be placed in from of the camera lens in order to hide it without hindering the cameras view. A USB port extender or converter is connected directly to the camera module on one side, and flush to the outside of the box on the other allowing access to the camera module. The LED is located directly on the camera module, and the small LED hole on top of the box grants the user visibility to it. All components are adhered to the interior surface of the box. The internal components are then covered with the ring cushion or insert.

A single button or flip switch is located in the back of the box. This button or switch is used for either turning on the device and initiating recording, or for stopping recording, saving the data, and shutting off the device.

We claim:

1. A ring box comprising:
an upper portion including an upper surface and a lower surface a rear edge and a front edge opposite the rear edge, the lower surface defining a first rim;
a lower portion including a lower surface and an upper surface, the upper surface defining a second rim, the first and second rims adjacent one another and connected to one another at the rear edges of the upper portion and the lower portion;
a camera lens positioned on an exterior surface of one of the front edge of the upper portion and the lower portion;
video camera components positioned within one of the upper and lower portions and capable of recording video, the video camera components connected to the camera lens; and
a user operated switch positioned on one of the upper portion and the lower portion, the switch connected to the video camera components, the switch capable of initiating and terminating the recording of the video camera components upon operation by the user.

2. The ring box of claim 1 wherein the switch is movable between a first position and a second position, wherein movement of the switch by a user to the second position initiates recording and wherein movement of the switch by a user to the first position terminates recording such that the user can control the length of the recording via operation of the switch.

3. The ring box of claim 2 wherein the switch is positioned on an exterior surface of the ring box.

4. The ring box of claim 3 wherein the switch is positioned on the rear edge of the lower portion.

5. The ring box of claim 4 wherein the camera lens is positioned on the front edge of the upper portion.

6. The ring box of claim 5 wherein the upper and lower portions are connected to one another with a hinge, such that the upper portion and the lower portion are capable of being moved between an open position and a closed position.

7. The ring box of claim 6 wherein the switch is capable of operating the video camera components to initiate recording when the box is in an open position and a closed position.

8. The ring box of claim 7 including an LED positioned on the ring box, the LED indicating when the video camera components are recording.

9. The ring box of claim 8 wherein the lower portion of the box includes a pouch for receiving a ring.

10. A ring box comprising:
a box having an upper portion hinged to a lower portion such that the box is movable between an open position with portions of the upper and lower portions spaced from one another and a closed portion with the upper portion abutting the lower portion, the lower portion including a pouch capable of receiving a ring, the upper portion and lower portion each including a front face opposite the hinge and a rear face adjacent the hinge;
a video camera lens positioned on the front face of the upper portion;
a video camera chip housed within the upper portion, the video camera chip connected to the video camera lens;
a user operable switch positioned on the rear face of the lower portion, the user operable switch capable of being manually operated by a user to control the video camera chip in order to initiate recording and terminate recording such that a user can operate the switch to control the length of the recording period independent of whether the box is in the open position or the closed position;
an indicator on one of the upper and lower portions, the indicator connected to the video camera chip, the indicator producing a signal only during the recording period; and
a USB port positioned on one of the upper and lower portions, the USB port connected to the camera chip for transferring information from the camera chip to a device connected to the USB port.
